(19) United States
(12) Patent Application Publication
(10) Pub. No.: US 2013/0062080 A1
(43) Pub. Date: Mar. 14, 2013

(54) SYSTEM AND METHOD FOR FIRE SUPPRESSION

(71) Applicants: Brendan P. Tobin, Tinton Falls, NJ (US); Gary E. Alleman, Newburg, PA (US)

(72) Inventors: Brendan P. Tobin, Tinton Falls, NJ (US); Gary E. Alleman, Newburg, PA (US)

(21) Appl. No.: 13/540,052

(22) Filed: Jul. 2, 2012

Related U.S. Application Data
(60) Provisional application No. 61/532,628, filed on Sep. 9, 2011.

(51) Int. Cl. A62C 2/00; A62C 31/28

(52) U.S. Cl. 169/46; 169/51

(57) ABSTRACT

A fire suppression apparatus, including a support stand including: a rigid surface; a support tube rigidly coupled to the rigid surface, the support tube having a major axis; a pipe disposed within the support tube, the pipe comprising a body having a first end and a second end, the pipe slidably and lockably coupled within the support tube and adjustable in a direction parallel to the major axis, wherein a length of the pipe is greater than a length of the support tube, and wherein the pipe is configured to transport a fluid from the first end to the second end; a valve coupled to the first end of the pipe; and a nozzle coupled to the second end of the pipe. A fire suppression method includes deploying interconnected apparatus at a desired separation distance and gradually increasing water flow through the apparatus.

### CROSS-REFERENCE TO RELATED APPLICATIONS

This application claims the benefit of U.S. Provisional Patent Application Ser. No. 61/532,628, filed on Sep. 9, 2011, the entire content of which is hereby incorporated by reference in its entirety.

### BACKGROUND

1. Field of the Invention

Embodiments of the present invention generally relate to a relocatable and extendible fire suppression apparatus, system and method, and in particular to a system that sprays water over an area for fire suppression.

2. Description of the Related Art

Automated sprayers are known from lawn care uses, but such sprayers generally are not both relocatable and extendible. Furthermore, that spray pattern is designed for watering rather than fire suppression.

### SUMMARY

Embodiments of the present invention generally relate to an extendible fire suppression apparatus, system and method, and in particular to a system that sprays water outdoors for fire suppression. The system may be used, for instance, to prevent, suppress, and/or extinguish a fire over an area. The fire may be, for example, a grass fire, brush fire, and so forth. The system may also be used to prevent, suppress, and/or extinguish structural fires by application of water. The area, when in the context of a structural fire, may include a roof, e.g., a flat-topped roof. The structural fire may be, for example, a fire threatened by or caused by a brush fire, forest fire, an adjoining building, or the like.

The apparatus may include a tripod coupled to a horizontal platform. An aperture is provided in the horizontal platform, and a support tube disposed within the aperture. A horizontal flange is coupled to both the support tube and to the horizontal platform, in order to substantially rigidly affix the support tube to the horizontal platform. A vertical water pipe is slidably provided within the support tube, substantially coaxially with the support tube. A fixation adjustment is coupled to the support tube, to affix the vertical water tube at a desired position within the support tube. A T-valve is operatively coupled to a lower end of the vertical water pipe, and a sprayer is operatively coupled to an upper end of the vertical water pipe. The T-valve is configured to accept coupling to a first hose supplying water via a first opening. The T-valve is further configured to accept coupling to a second hose that discharges water via a second opening. A control is provided on the T-valve to adjust an amount of water provided into the vertical water pipe. Water in the vertical water pipe travels from the T-valve to the sprayer. The sprayer in turn sprays water over an adjustable spray pattern.

A fire suppression system may include a plurality of fire suppression apparatus, each operatively coupled to at least one neighboring fire suppression apparatus by use of a fire hose.

Embodiments in accordance with the present invention may include a fire suppression apparatus, including a support stand including: a rigid surface; a support tube rigidly coupled to the rigid surface, the support tube having a major axis; a pipe disposed within the support tube, the pipe comprising a body having a first end and a second end, the pipe slidably and lockably coupled within the support tube and adjustable in a direction parallel to the major axis, wherein a length of the pipe is greater than a length of the support tube, and wherein the pipe is configured to transport a fluid from the first end to the second end; a valve coupled to the first end of the pipe; and a nozzle coupled to the second end of the pipe.

Embodiments in accordance with the present invention may also include a fire suppression method that includes deploying interconnected apparatus at a desired separation distance and gradually increasing water flow through the apparatus.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments encompassed within the scope of the present invention, and, therefore, are not to be considered limiting, for the present invention may admit to other equally effective embodiments, wherein:

FIG. 1 illustrates an apparatus in a first position, in accordance with an embodiment of the present invention;

FIG. 2 illustrates an apparatus in a second position, in accordance with an embodiment of the present invention;

FIG. 3 illustrates a T-valve in accordance with an embodiment of the present invention;

FIG. 4 illustrates a lower portion of an apparatus in a stowed position, in accordance with an embodiment of the present invention;

FIG. 5 illustrates a central portion of an apparatus, in accordance with an embodiment of the present invention;

FIG. 6 illustrates an upper portion of an apparatus, in accordance with an embodiment of the present invention;

FIG. 7 illustrates an apparatus in a stowed and secured position, in accordance with an embodiment of the present invention; and

FIG. 8 illustrates a fire suppression system in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures. Optional portions of the figures may be illustrated using dashed or dotted lines.

### DETAILED DESCRIPTION

Embodiments of the present invention generally relate to an extendible water-spraying apparatus, system and method, and in particular to a system that sprays water over an area for fire suppression. The system may be used, for instance, to prevent, suppress, and/or extinguish a fire outdoors. The fire may be, for example, a grass fire, brush fire, forest fire, debris fire and so forth. The system may also be used to prevent, suppress, and/or extinguish structural fires by application of water over an area that may include a roof, e.g., a flat-topped roof, or walls that may be exposed to a fire. The water may act to reduce or extinguish a fire, and/or substantially prevent the ignition of a fire from embers, and/or dampen and cool the area to lessen susceptibility to and sustainability of a fire. The structural fire may be, for example, a fire threatened by or caused by a grass fire, brush fire, forest fire, debris fire, tanker fire, ignition from an adjoining structure, or the like.

The water-spraying apparatus and system can be used for other purposes, for example rapidly irrigating a field of crops or other vegetation over a deployable area. The apparatus and system may be used to irrigate a portion of such a field, then quickly moved to irrigate a different portion of the field. The apparatus and system may also be used, for example, to provide cooling of a large outdoor summer crowd at a concert or a waterpark, etc.

The extendible fire suppression apparatus may be operatively connected to one or more other extendible fire suppression apparatus, in order to create a fire suppression apparatus system.

The water-spraying apparatus may be designed for rapid deployment by firefighters, for example by usage of lightweight materials, carrying straps, and being stowable when unused in an easily unstowed or unfolded configuration. The apparatus should be deployable with minimal need for training or retraining, or time-consuming instructions.

Embodiments in accordance with the present invention allow one or more firefighters to rapidly deploy multiple units to create a wall of water to wet down an effective working area ranging from 100 linear feet to 500 linear feet or more just by using hydrant or other water source pressure of at a minimum of 30 pounds per square inch (“PSI”). Greater coverage can be attained through higher PSI from a fire engine or other stronger pump. Adjustable sprayheads allow for a spray radius ranging from one foot wide to a full circle up to a 100 foot radius. This allows the fire service to cover a larger area than currently possible using the current “fire line” method of using a hose attached to a fire engine with one firefighter stretching the line and another operating the truck. Embodiments in accordance with the present invention provide a greatly added reach and operation range than known systems, and can do so more quickly, allowing for faster and better response, faster and better fire suppression, less damage, and lower insurance costs.

Embodiments in accordance with the present invention are lightweight, are adjustable for stabilizing in various terrain, and the embodiments encompass firefighting technology that would allow for proper, safe, dedicated operation with little to no training by firefighters or by others, including civilians. This ease of use and speed of deployment also empowers and extends manpower to allow for more work to be done, faster, at a lower cost, and with far less danger to firefighters or the public.

Currently, there is nothing else of the scope of the embodiments in accordance with the present invention “Water Walls” available in the fire industry or any other industry. The invention allows firefighters, farmers, Parks Departments employees, homeowners, and other users to rapidly deploy a system of broadcast spray pattern tools to quickly wet down a large area even with limited resources or manpower, reducing damage, danger, labor costs, and problems currently related to fire suppression, farming, irrigation, and similar tactical, widespread area, water coverage operations.

The extendible fire suppression apparatus includes an elevation stand adapted to elevate a water nozzle at an elevation height selected to provide an improved throw distance for water at a predetermined pressure and flow rate. If the elevation height is too low, water will not be thrown far enough. Applicants have discovered that if the elevation is too high, or if an elevation angle at which water is thrown is too high, water also will not be thrown far enough, or may not be delivered to the desired area, because wind and air resistance may interfere with the thrown water (e.g., excessively breaking up the stream of thrown water, or blowing it off course). In one embodiment in accordance with the present invention, the height of the elevation stand is about three feet to about nine feet. The elevation stand may be, for instance, a surveyor's tripod. The elevation stand may further include adjustable legs, such that a position of a leg may be changed, or the length of the leg may be changed, in order to at least partially compensate for uneven terrain and/or obstructions (e.g., rocks, logs, gulleys, etc.) under and near the elevation stand. The legs may include anti-slip feet, e.g., by including spikes, cleats, or other feature designed to go into and/or be more secured to the ground, or otherwise improve grip with a support surface. The elevation stand may include hooks, stabilizing lines, or the like in order to secure the elevation stand to a relatively immobile nearby object such as a boulder, tree, or outcropping.

The elevation stand may be constructed from a relatively lightweight material, such as aluminum or fiberglass, for ease of carrying as it is being deployed. The elevation stand may also include a carrying strap, handle, or the like in order to facilitate carrying the elevation stand.

The elevation stand includes a platform having a generally horizontal major surface, a thickness defined in the vertical direction, and a passageway extending generally vertically through the platform. A substantially rigid support tube having a central axis is disposed in the passageway, the support tube having a length greater than the thickness of the platform. The support tube includes a flange, collar or the like (“flange”) that extends radially in a direction generally perpendicular to the central axis. The flange lays generally flat on the horizontal major surface of the platform, in order to provide stability to the support tube. The flange may be fixably attached to the major surface of the platform, for instance by way of a clamp, bolt, welding, adhesive, or the like. The flange acts to stabilize and/or lock in place the support tube relative to the platform. The flange may have one of a variety of shapes, such as circular, triangular, or a shape substantially conforming to the shape of the horizontal major surface of the platform. The flange is used to keep the support tube substantially rigid with respect to the horizontal major surface of the platform. The rigidity tends to prevent wobble or other instability in the support tube which would affect where water is sprayed, or may cause the apparatus to fall over.

A water pipe, conduit or the like (“water pipe”) is disposed through the support tube. The support tube includes a releasable locking apparatus to stabilize and/or lock in place the water pipe in the support tube. The locking apparatus may be released in order to adjust the vertical position of the water pipe in the support tube. The releasable locking apparatus may be, for example, a threaded bolt or the like which, when screwed toward the interior of the support tube, engages with a rigid portion of the water pipe to press the water pipe against a stop (e.g., an opposite inner surface of the support tube) in order to hold the water pipe in place.

A bottom end of the water pipe includes a T-junction and valve. One port of the T-junction is connected to a water source. A second port of the T-junction may be either configured to deliver water to an adjoining location, or may be capped to prevent the flow of water through the second port. The first and second ports are oriented generally horizontally. The third port of the T-junction is oriented generally vertically and is coupled to the water pipe. The T-junction allows a controllable amount of water to flow upward through the water pipe, for instance by way of an adjustable valve on the third port of the T-junction.

As a flow rate of water in the hose and T-junction changes (e.g., as the water supply is being turned on or off), forces may be induced in the hose and T-junction. To help prevent the apparatus from toppling due to forces induced in the hose and T-junction, the flow rate of water should be changed gradually over a period of about 5-10 seconds. Alternatively, or in addition, the T-junction may be located in a relatively low position relative to the overall apparatus (e.g., below a center of gravity) so that the forces induced in the hose and T-junction will be less likely to topple the apparatus.

A top end of the water pipe is coupled to a spray nozzle. The spray nozzle may be rotatable over a predetermined swept azimuth angle and constant but adjustable elevation angle. The elevation angle may be set in order to provide water spray as high as about the second floor of a building. However, ordinarily in an open space the elevation angle will be set lower to provide a relatively longer spray distance of the water spray. To effectively combat a grass fire or other wildfire, the spray distance should be at least twice the height of the flames, in order to provide a sufficiently wide moisture barrier that will wet potential fuel, absorb heat, and extinguish embers. The spray nozzle may be capable of projecting a stream or spray of water over a relatively long maximum throw distance (e.g., up to about 50-70 feet or farther) at the pressures and flow rates ordinarily available from a fire hydrant, fire company pumping engine, or stand-alone pump usable to draw water from a natural source. For example, a source pressure of at least 30 PSI was found to be usable with embodiments in accordance with the present minimum operating size of the invention. Larger volume models require higher minimum PSI, from 35-to-55 PSI for minimum operating area and water distance for each unit. A relatively smaller amount of water sprayed from the water pipe may fall or spray over a shorter distance, between the elevation stand and the maximum throw distance, in order to wet those areas and the wet the elevation stand. Wetting the elevation stand this way helps avoid heat-related damage to the elevation stand.

The water pressure, throw distance, water volume (in gallons per minute, “GPM”) and fixture sizes are interrelated design parameters and are based on prototype units, pipe sizes and spray head size that were tested. The prototype size was chosen based on flow rate minimums to effectively cover the desired area while also allowing for light weight for stowing and deployment. For example, a 1.0″ pipe connection to the 0.75″ connector on the spray nozzle as used in the prototype may provide a minimum flow rate at 30 PSI at about 4 GPM with a throw distance of about 40 feet or more. However, the 1.0″ pipe connection may also provide a flow rate at 60 PSI at about 14 GPM with a throw distance of about 50 feet or more. For a 1.0″ spray nozzle connector, the water pressure should be a minimum of about 30 to 35 PSI in order to provide adequate throw distance. For a 1.25″ spray nozzle connection, the water pressure should be a minimum of about 55 PSI in order to provide adequate throw distance. However, larger pipe connections may employ larger T-valve connectors, larger hoses, larger center pipes, etc. in order to support a larger flow rate. This may add additional weight, which may affect the mechanical design of the tripod.

The extendible fire suppression apparatus is capable of being connected in a daisy-chain manner to an adjoining extendible fire suppression apparatus, by use of fire-fighting hose connected between the T-junctions of the respective extendible fire suppression apparatus. The last fire suppression apparatus in such a daisy chain may have a plug or cap in the second port of its T-junction. Use of fire-fighting hose allows for flexible and reconfigurable placement of individual fire suppression apparatus units, for instance by placing the apparatus units at uneven separations or by placing them in a curved disposition, corner shape, or otherwise non-linear disposition. Fire-fighting hose is commonly available in 50-foot sections, which may be interconnected to form longer sections of fire-fighting hose. Therefore, the separation between apparatus units may be in the range of about 50 feet to about 200 feet. The fire-fighting hose has adequate flow capacity to support up to about six daisy-chained fire suppression apparatus under adequate PSI pressure. Fire-fighting hose may be pre-connected to some of the T-junctions in advance, such that less time is needed during deployment by avoiding the need to attach hoses. Support straps may be provided in order to help keep the hose in a stowed and easily deployable position prior to use, during storage and as the fire suppression apparatus is being positioned for deployment.

In operation of a system of daisy-chained fire suppression apparatus, the individual fire suppression apparatus are first positioned in the desired locations, without flowing water. Then the water through the fire hose is turned on gradually, up to full flow rate over a period of about 5-10 seconds. If the water is turned on too quickly, the change in pressure may cause individual fire suppression apparatus to topple over. Toppled apparatus can ordinarily be righted, but valuable time may be lost. Once the system is operating at full flow rate, the weight of the fire-fighting hose and water therein (approximately 150 pounds) is ordinarily adequate to keep the individual fire suppression apparatus in place without toppling over. The swept angles for the nozzles can be adjusted in or out to project the water to the desired areas.

The fire suppression apparatus and system should be capable of unattended operation for an extended period of time. This includes reliability, sturdiness, and resistance to environment conditions likely to be encountered in or near a fire, such as heat, open flames, water exposure, wind, ashes/soot/debris, etc.

Furthermore, because the fire suppression apparatus and system is often deployed in remote areas, it should be lightweight yet heavy duty. For example, the tripod should be heavy duty, similar to that of a surveyor-grade tripod. For basic outdoor work, the water hose interconnecting the fire suppression apparatus may be a forest-fire grade hose (1.5 inch diameter), rather than a structural grade hose (3 inch diameter), because of a significant savings in weight. The forest-fire grade hose is about one-third the weight per unit length compared to a structural grade hose. Forest-fire grade hose is adequate because the fire suppression apparatus is designed primarily for outdoor use, thus there is no need for heavier structural-fire grade fire hose, and thereby lightening the system.

The vertical water pipe may be a standard size pipe of approximately one inch in diameter from the T-valve to the spray head (i.e., spray nozzle). The T-valve may be a butterfly style globe valve in order to regulate the volume of water going up the pipe to the spray head.

In order to facilitate easy carry and quick deployment, the tripod legs and hose sections may be held in place during carrying or storage time by flexible quick release straps, such as nylon straps. The straps may wrap around the base of the tripod near the feet and/or near the top of the tripod. A flexible carry handle may be provided along with the flexible straps. A flexible mounted zipper pouch may also be included. With such flexible straps, it may be possible to carry several apparatus at a single time for rapid deployment. Two straps may also be usable to hold the forestry-grade hose in place for rapid deployment and ease of carrying and storing.

During deployment, a first hose of a standard length (e.g., 50 foot hose length) may be attached to a water source such as a fire hydrant, fire engine pump, other pump, etc. The first hose may then be unrolled, and the far end of the first hose may be attached to a first port of a T-valve of an apparatus. A second hose of a standard length (e.g., 50 foot hose length) may be attached to a second port of the T-valve of the apparatus, and the process may be repeated until a last apparatus in the chain is attached. The second port of the T-valve of the last apparatus may be capped. The apparatus tripods may be stabilized, and a desired spray pattern and/or radius may be set. The operator then starts the water flow gradually, over a period of approximately 5-10 seconds so that the apparatus are not toppled by the force of water surging in the hoses. The apparatus and system may then run on their own until the fire danger passes or a desired water soaking level has been achieved, as determined by an operator.

Other embodiments in accordance with the present invention may include system configurations other than a linear arrangement of apparatus. For example, with an appropriate junction valve, a Y-shaped system configuration of apparatus may be deployed.

Embodiments in accordance with the present invention may be reconfigurable during operation in order to adjust the apparatus and/or system in response to changing fire conditions. Accordingly, adjustments to the apparatus and system may be made by hand or hand-held tools while wearing fire-protective gloves, via appropriately-sized controls, and be able to be accomplished relatively quickly. For example, spring-loaded clips may be used to adjust the spray angular range and spray distance of the spray nozzles.

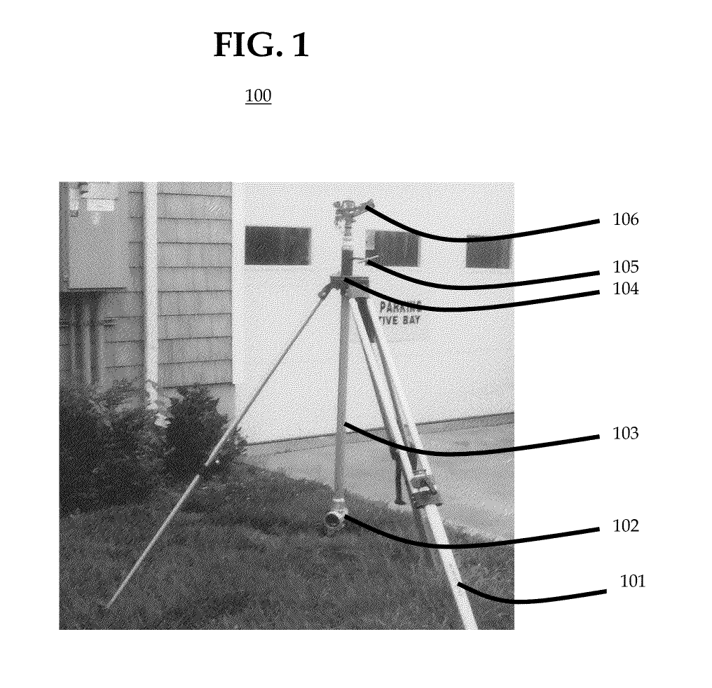

FIG. 1 illustrates a fire suppression apparatus 100 in accordance with an embodiment of the invention. Apparatus 100 includes a tripod 101 wherein the top ends of the legs of tripod 101 are coupled to a horizontal platform 104. Vertical water pipe 103 runs through horizontal platform 104. A lower end of vertical water pipe 103 is coupled to a T-valve 102. A top end of vertical water pipe 103 is coupled to spray nozzle 106. An adjustment handle 105 is used to secure vertical water pipe 103 in a desired vertical position. FIG. 1 illustrates vertical water pipe 103 in a relatively low position.

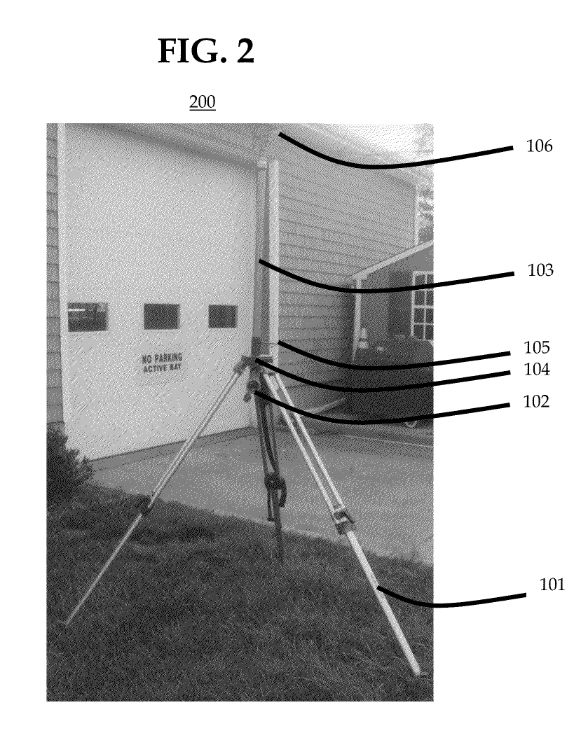

FIG. 2 illustrates a fire suppression apparatus 200 in accordance with an embodiment of the invention. Parts of apparatus 200 that are in common with apparatus 100 of FIG. 1 are marked with common reference numbers. Apparatus 200 is shown in an elevated position, relative to the position of apparatus 100.

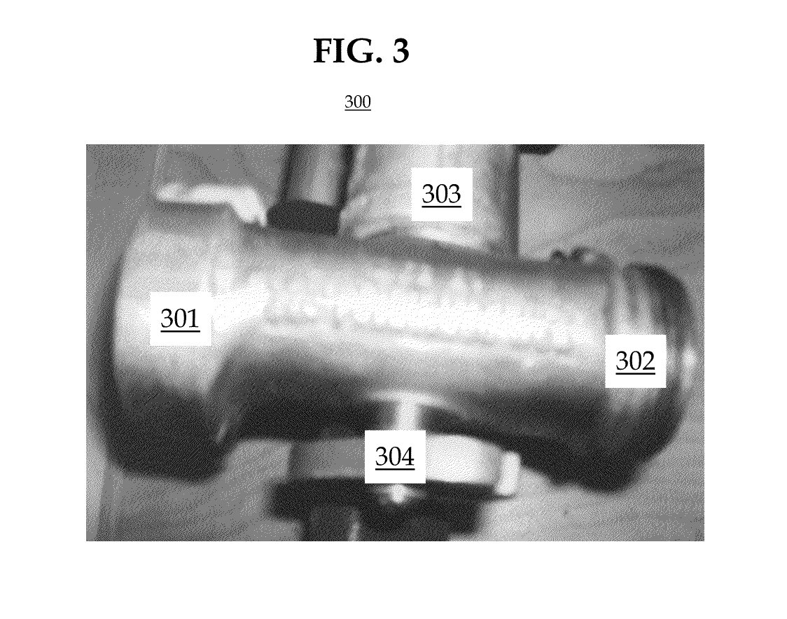

FIG. 3 illustrates a T-valve 300 in accordance with an embodiment of the invention. T-valve 300 includes a first port 301 to which a hose supplying water is coupled. T-valve 300 includes a second port 302 to which either a hose taking away water is coupled, or a plug (or cap) is coupled. T-valve 300 includes a third port 303 to which vertical water pipe of FIG. 1 is coupled. T-valve 300 includes a control handle 304 which controls the flow of water into the third port 303.

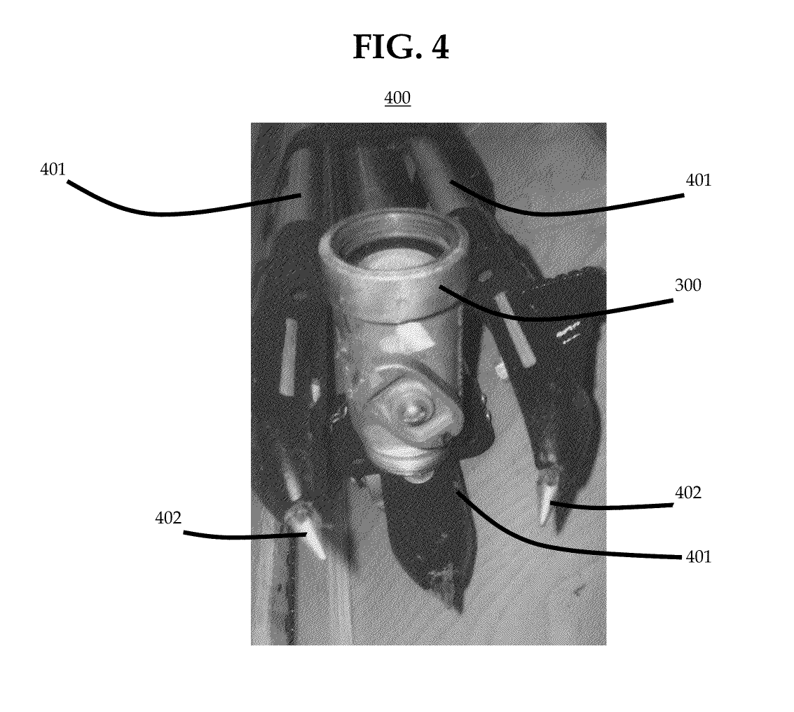

FIG. 4 illustrates an apparatus 400, in particular a lower portion of apparatus 400, in a closed position. Illustrated in FIG. 4 is T-valve 300, and also illustrated is a plurality of legs 401. Legs 401 are depicted as including a claw 402 at a lower end. Claw 402 may also be implemented in the form of a cleat, hook, or the like. The function of claw 402 is to help secure the bottom of leg 401 to the ground when apparatus 400 is positioned in an upright and deployed position.

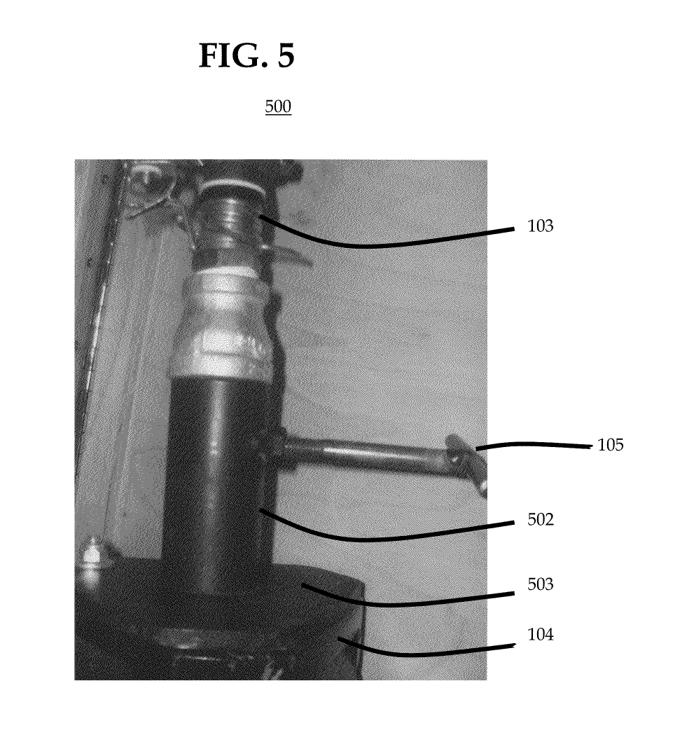

FIG. 5 illustrates a central portion 500 of the apparatus 100 that is illustrated in FIG. 1, in accordance with an embodiment of the invention. Central portion 500 includes a support tube 502, and flange 503 that is coupled to support tube 502 and horizontal platform 104. Vertical water pipe 103 is concentrically disposed within support tube 502. Vertical water pipe 103 may be vertically adjusted within support tube 502. When vertical water pipe 103 is at a desired vertical position, adjustment handle 105 may be used to secure vertical water pipe 103 at that position. Flange 503, being coupled to both support tube 502 and horizontal platform 104, keeps support tube 502 substantially rigidly affixed to apparatus 100.

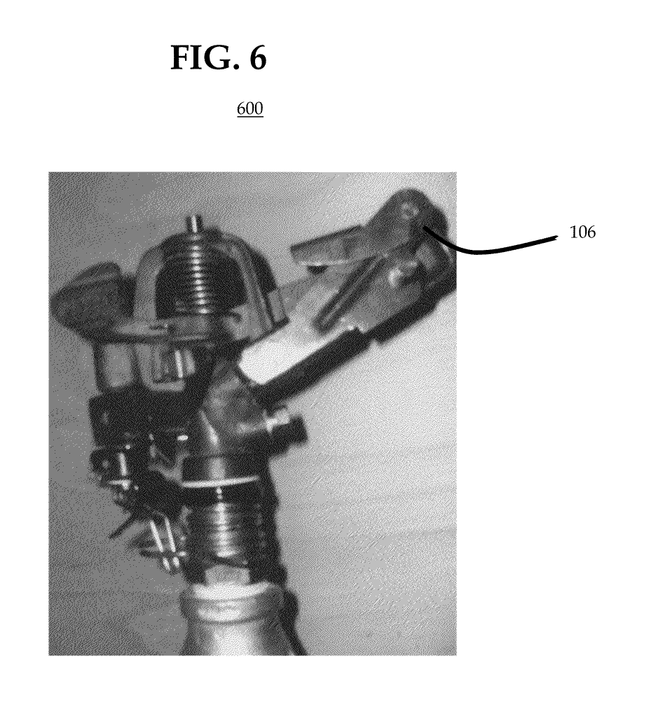

FIG. 6 illustrates an upper portion 600 of the apparatus 100 that is illustrated in FIG. 1, in accordance with an embodiment of the invention. Upper portion 600 illustrates an expanded view of spray nozzle 106 with adjustable spray pattern.

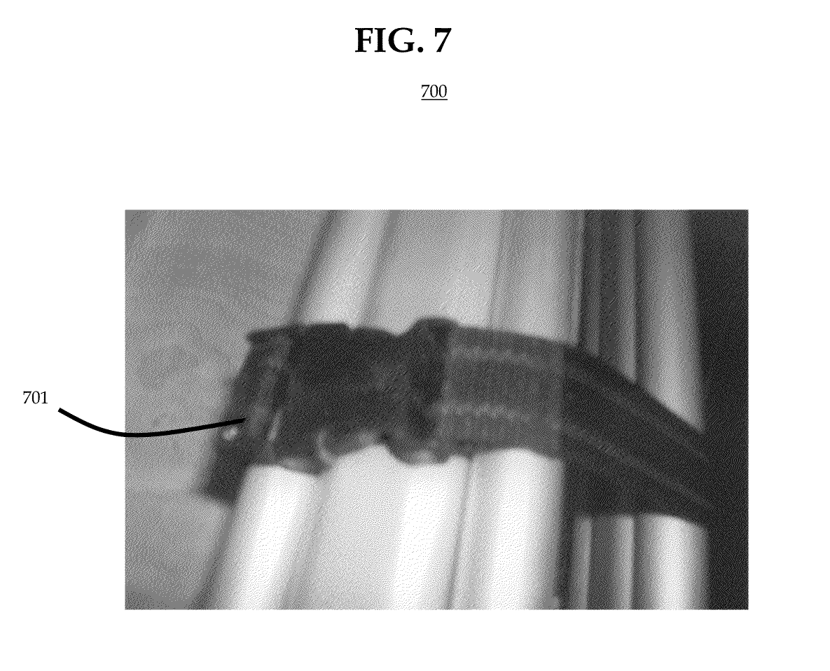

FIG. 7 illustrates a fire suppression apparatus in a stowed position and secured by flexible strap 701, in accordance with an embodiment of the present invention. Another flexible strap (not shown in FIG. 7) may be provided near the top of the apparatus.

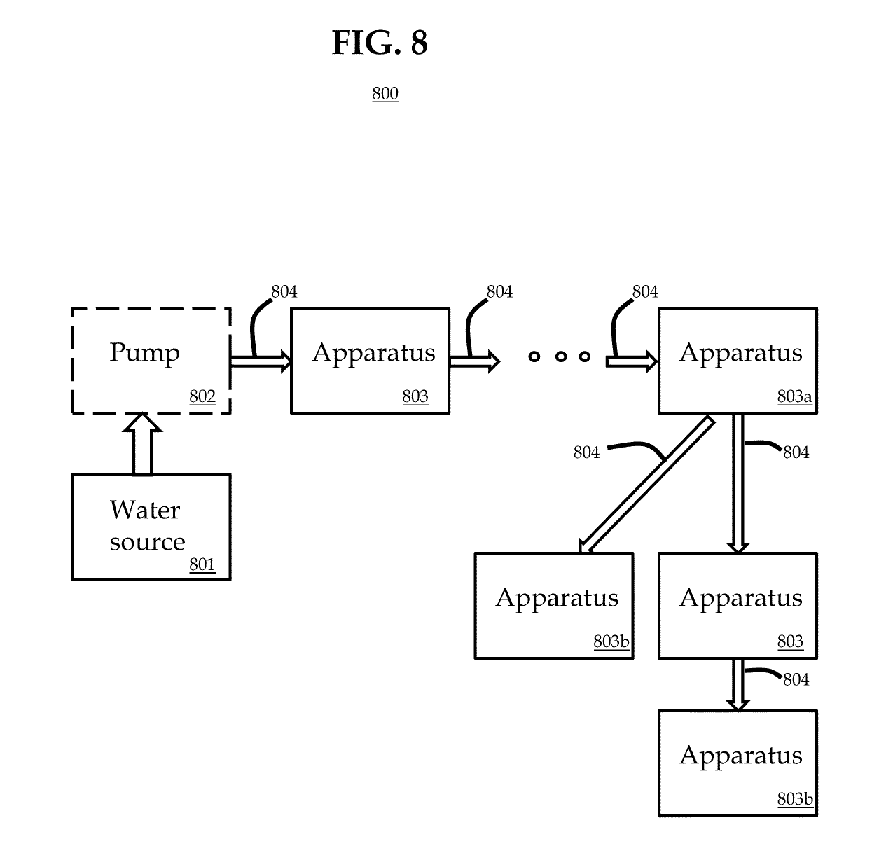

FIG. 8 illustrates a fire suppression system 800 in accordance with an embodiment of the invention. Water is drawn from a water source 801. Water source 801 may be a fire hydrant, fire engine, natural water source (e.g., lake, river, etc.) and so forth. System 800 may include an optional pump 802 (as indicated by a dashed outline in FIG. 8) if sufficient water pressure is not already available from water source 801. Pump 802 is coupled to hose 804, which in turn is coupled to at least one fire suppression apparatus 803. Fire suppression apparatus 803 may be coupled to additional fire suppression apparatus 803 by use of additional sections of hose 804.

One or more of the apparatus such as fire suppression apparatus 803a may be coupled to a junction valve that supports a Y-shaped configuration, as described above. One or more of the apparatus such as fire suppression apparatus 803b, which are located at the end of a linear connection of apparatus, may have plugged or capped the second port of their respective T-valve 300.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the present invention to the precise form disclosed. Modifications and variations may be possible in light of the above teachings or may be acquired from practice of the present invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶6, and any claim without the word “means” is not so intended.

We claim:

1. A fire suppression apparatus, comprising:
a support stand comprising a rigid surface;
a support tube rigidly coupled to the rigid surface, the support tube having a major axis;
a pipe disposed within the support tube, the pipe comprising a body having a first end and a second end, the pipe slidably and lockably coupled within the support tube and adjustable in a direction parallel to the major axis, wherein a length of the pipe is greater than a length of the support tube, and wherein the pipe is configured to transport a fluid from the first end to the second end;
a valve coupled to the first end of the pipe; and
a nozzle coupled to the second end of the pipe.

2. The apparatus of claim 1, wherein the rigid surface comprises:
a substantially planar surface oriented substantially perpendicular to the major axis of the support tube; and
an aperture through the substantially planar surface, wherein the aperture is configured to receive the support tube.

3. The apparatus of claim 1, wherein the support tube comprises a support member rigidly coupled to the rigid surface.

4. The apparatus of claim 3, wherein the support member comprises a flange having a substantially planar surface fixably coupled to the rigid surface of the support stand.

5. The apparatus of claim 3, wherein the support member comprises one or more arms fixably coupled to the rigid surface of the support stand.

6. The apparatus of claim 1, wherein the valve comprises:
a first port configured to accept a fluid from a first fire hose;
a second port configured to discharge at least a portion of the fluid into a second fire hose;
a third port configured to discharge at least a portion of the fluid into the pipe; and
a control configured to adjust the portion of the fluid that is discharged into the pipe.

7. The apparatus of claim 6, wherein the valve comprises a fourth port configured to discharge at least a portion of the fluid into a third fire hose.

8. The apparatus of claim 1, wherein the nozzle is rotatable over a predetermined swept azimuth angle and at a constant but adjustable elevation angle.

9. The apparatus of claim 1, wherein the nozzle is adjustable to a height of about three feet to about nine feet, by slidably adjusting a coupling of the pipe to the support tube.

10. The apparatus of claim 8, wherein the nozzle is configured to project a fluid at least 50 feet at a fluid pressure in the pipe of at least 30 PSI.

11. The apparatus of claim 1, wherein the nozzle is hand-adjustable while wearing fire-protective gloves.

12. The apparatus of claim 1, wherein the support stand comprises adjustable legs to compensate for uneven terrain.

13. The apparatus of claim 1, wherein the support stand comprises anti-slip features configured to improve grip to a support surface.

14. The apparatus of claim 1, wherein the support stand is configured to be securable to a relatively immobile object.

15. A method to suppress a fire, comprising:
providing one or more fire suppression apparatus, the fire suppression apparatus comprising:
a support stand comprising a rigid surface;
a support tube rigidly coupled to the rigid surface, the support tube having a major axis;
a pipe disposed within the support tube, the pipe comprising a body having a first end and a second end, the pipe slidably and lockably coupled within the support tube and adjustable in a direction parallel to the major axis, wherein a length of the pipe is greater than a length of the support tube, and wherein the pipe is configured to transport a fluid from the first end to the second end;
a valve coupled to the first end of the pipe; and
a nozzle coupled to the second end of the pipe;
separating the one or more fire suppression apparatus by a distance of about 50 feet to about 200 feet;
interconnecting the one or more fire suppression apparatus with fire hoses; and
gradually increasing a flow of fluid through the fire hoses, from no flow to full flow rate.

16. The method of claim 15, further comprising adjusting the nozzle to be rotatable over a predetermined swept azimuth angle and at a constant but adjustable elevation angle, in order to project a fluid at least about 50 feet.

17. The method of claim 15, further comprising slidably adjusting a coupling of the pipe to the support tube in order to set the nozzle to a height of about three feet to about nine feet.

18. The method of claim 15, wherein the step of gradually increasing a flow of fluid takes place over a period of about 5 seconds to about 10 seconds.

19. The method of claim 15, wherein the one or more fire suppression apparatus are interconnected with fire hoses before the step of separating the one or more fire suppression apparatus.
